(19) United States
(12) Patent Application Publication
(10) Pub. No.: US 2013/0321245 A1
(43) Pub. Date: Dec. 5, 2013

(54) MOBILE DEVICE FOR MONITORING AND CONTROLLING FACILITY SYSTEMS

(71) Applicant: Henry Steve HARPER, Humble, TX (US)

(72) Inventor: Henry Steve HARPER, Humble, TX (US)

(73) Assignee: FLUOR TECHNOLOGIES CORPORATION, Aliso Viejo, CA (US)

(21) Appl. No.: 13/488,264

(22) Filed: Jun. 4, 2012

(51) Int. Cl. G09G 5/00

(52) U.S. Cl. 345/7

(57) ABSTRACT

A mobile device for monitoring and controlling systems while moving about within a facility is described. The mobile device includes a processor, memory, a display, and software for viewing and managing system data. The device provides produces augmented views of the facility by overlaying actual facility video camera images with other sensor derived data, identification data, and control recommendations. The device generates the control recommendations based, in part, on the device's location and orientation, and on system operation rules and parameters.

### FIELD OF THE INVENTIVE SUBJECT MATTER

The field of the inventive subject matter is mobile devices for centrally controlling systems within a facility.

### BACKGROUND

It is known to build a control room in order to monitor and control a large facility from a centralized location. Such control rooms are frequently used in manufacturing plants, power plants, buildings, and other facilities, to monitor and control various functions of the facility, for example monitoring the air conditioning or transport units within the facility. While central control rooms are advantageous in some aspects, one drawback is that a controls manager must be present in the control room to make adjustments to the facility. For large facilities, this means that the controls manager is prevented from being able to observe a problem in person. Since human senses can frequently observe things that a computer monitor might miss, the controls manager is at significant disadvantage by being restrained to a control room.

Others have addressed this problem by providing remote devices that communicate with a control room. U.S. Pat. No. 7,143,149 to Oberg, for example, describes an interactive mobile wireless unit that allows an operator to communicate remotely with the control system of an industrial plant. Oberg also contemplates that access to the central controls of the facility can be limited based on the location of the mobile wireless unit.

Other examples of remote devices for centrally controlling a facility include EP1898563, JP2009515236, U.S. Pat. No. 7,687,741, US20080120335, and US20110245932. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unfortunately, these references fail to appreciate that a mobile control device for centrally controlling systems within a facility can utilize location and orientation data to generate control recommendations. These references also fail to provide a mobile device that can produce augmented images to assist a controls manager with controlling a facility. Specifically, it would be advantageous to produce augmented images that include data from multiple sources (e.g., optical sensors, thermals sensors, acoustic sensors, building plans, 3D models, equipment/system data) and that associates the data in an intelligent manner.

Thus, there is still a need for improved mobile control devices for controlling systems within a facility.

### SUMMARY OF THE INVENTIVE SUBJECT MATTER

The inventive subject matter provides apparatus, systems and methods in which a mobile control device can be used to monitor and control a plurality of systems within a facility. The mobile control device includes a processor, an electronic storage medium, a display, a wireless transceiver, and electronically executable instructions (e.g., software code, script) for performing various functions (referred to herein for convenience as “modules”). The wireless transceiver is configured to communicate and exchange data with the plurality of systems, either directly or indirectly via a central control server. The software modules include:
(i) a location module that determines and tracks the location of the mobile control device; location data gathered by the location module is stored on the electronic storage medium as location data objects;
(ii) an orientation module that determines an orientation of the mobile control device with respect to the systems and the facility; orientation data gathered by the orientation module is stored on the electronic storage medium as orientation data objects;
(iii) a recommendation module that generates a control recommendation as a function of the location and orientation data objects and displays the recommendation on the display;
(iv) a controls module that processes system data objects received from at least one of the plurality of systems; the system data objects represent system operational parameters;
(v) a command module for transmitting and logging commands to the plurality of systems.

As used herein, the term “module” refers to a function provided by a set of executable instructions (e.g., software code).

In other aspects of some embodiments, the mobile device additionally includes a thermal sensor and an optical sensor for gathering thermal data and optical data, respectively. The thermal data and optical data can be stored on the electronic storage medium as thermal data objects and optical data objects.

In another aspect, the mobile device also includes an image module that produces and displays an image on the display. The image can include thermal data, optical data and other data as appropriate. In some embodiments, the image primarily comprises optical data. Thermal and other data can overlay portions of the optical data and associated with the optical data. Association can be made simply by where the data is overlaid, or by using labels, markers, and the like. Furthermore, the image module can be configured to select the data to include in the image based on rules provided (e.g., the maximum temperature at which a system can be safely operated).

In other aspects, the image module can be configured to associate thermal and other data with optical data as a function of the devices locations (e.g., gps coordinates) and orientation (e.g., which system the device is facing).

In yet other aspects of some embodiments, the mobile device's executable instructions further includes an optical recognition module that can recognize and identify optical data, such as a human face, text, numbers, logos, systems, and devices. It is also contemplated that real-life objects can be embedded with an identifier object, such as a logo or a radio frequency identification objection, with which the recognition module is already familiar. Once optical data is recognized and identified, the recommendation module and/or image module can associate identification data (e.g., employee name and position, system model number and operational handbook) with the optical data and display the identification data to a user via the display.

In another aspect of some embodiments, the recommendation module and/or the image module is configured to produce an image that includes optical data and a recommendation associated with the optical data. The recommendation module can also log whether a recommendation has been implemented by a user and display a recommendation status to the user (e.g., pending, completed, rejected, expired, etc).

In some applications, the mobile device can include a mount for attaching the mobile device to another device, such as a helmet or a vehicle. Such applications allow a controls manager to more easily navigate throughout a large facility without having to hold the mobile device with his or her hands. The mobile device's electronic storage medium preferably includes facility layout data objects that represent a layout of the facility. The image module can display an image of the layout, including the mobile device's location and orientation with respect to the layout. Furthermore, the image module can be configured to overlay a graphic of the facility layout, or at least portions of the layout, with an actual image of the layout as seen from the control manager's (i.e., the mobile device user's) perspective. In other aspects, when the user is a robot, the mobile device allows a control manager to view the facility and facility systems from the perspective of the robot.

In another aspect of some embodiments, the mobile device can include an interface for receiving user commands. Interfaces may include touch screens, keyboards, voice command recognition, buttons, and the like.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of one embodiment of a mobile control device.

FIG. 2 is a perspective view of another embodiment of a mobile control device.

FIG. 3 is a schematic of a facility layout, showing different systems within the facility.

FIG. 4 is a schematic of a mobile control device in communication with various system facilities.

FIG. 5a is a representation of a display for a mobile control device, showing image data of a system.

FIG. 5b is the display of FIG. 5a, which has been modified to include thermal data and recommendation data.

### DETAILED DESCRIPTION

It should be noted that while the following description is drawn to a mobile control device for controlling systems within a facility, various alternative configurations are also deemed suitable and may employ various computing devices including servers, interfaces, systems, databases, agents, peers, engines, controllers, or other types of computing devices operating individually or collectively. One should appreciate the computing devices generally comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, operation modules, or other functionality as discussed below with respect to the disclosed apparatus. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

One should appreciate that the disclosed techniques provide many advantageous technical effects including improved devices and methods for monitoring and controlling systems while moving throughout a facility.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

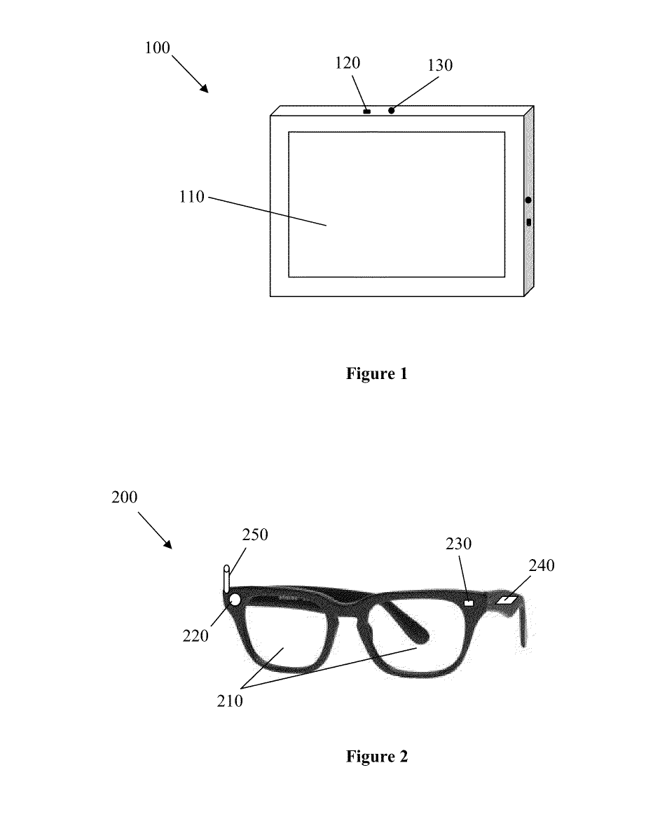

In FIG. 1 is a perspective view of a mobile control device 100. Device 100 is a touch screen tablet computer. Device 100 has a touch screen display 110 that serves to display information to a user and receive user inputs. Device 100 has standard computing components, such as a processor, an electronic storage medium, and executable code stored on the electronic storage medium. Computing components are well known and are constantly evolving as technology advances. Any commercially available computing components capable of performing the functions described herein are contemplated.

Device 100 may have an optical sensor 120 (e.g., a video camera) and a thermal sensor 130 (e.g., thermal image camera) located on one of the sides of device 100. Device 100 can include additional sensors as needed. Device 100 has a wireless transceiver stored internally within the housing of device 100 for communication with external devices, servers, services, and systems. The back side of device 100 (not shown) can include a mount for mounting device 100 to another device. Mounts are well known and any fastener capable of securely coupling device 100 to an external structure is contemplated. Vehicles and helmets are specifically contemplated external structures; however, those of skill in the art will appreciate that other structures can be used consistently with the inventive subject matter disclosed herein.

Contemplated users of device 100 include human and non-human (e.g., mobile robots) users. Examples of human users include, but are not limited to, system controls managers, home owners, and security personnel.

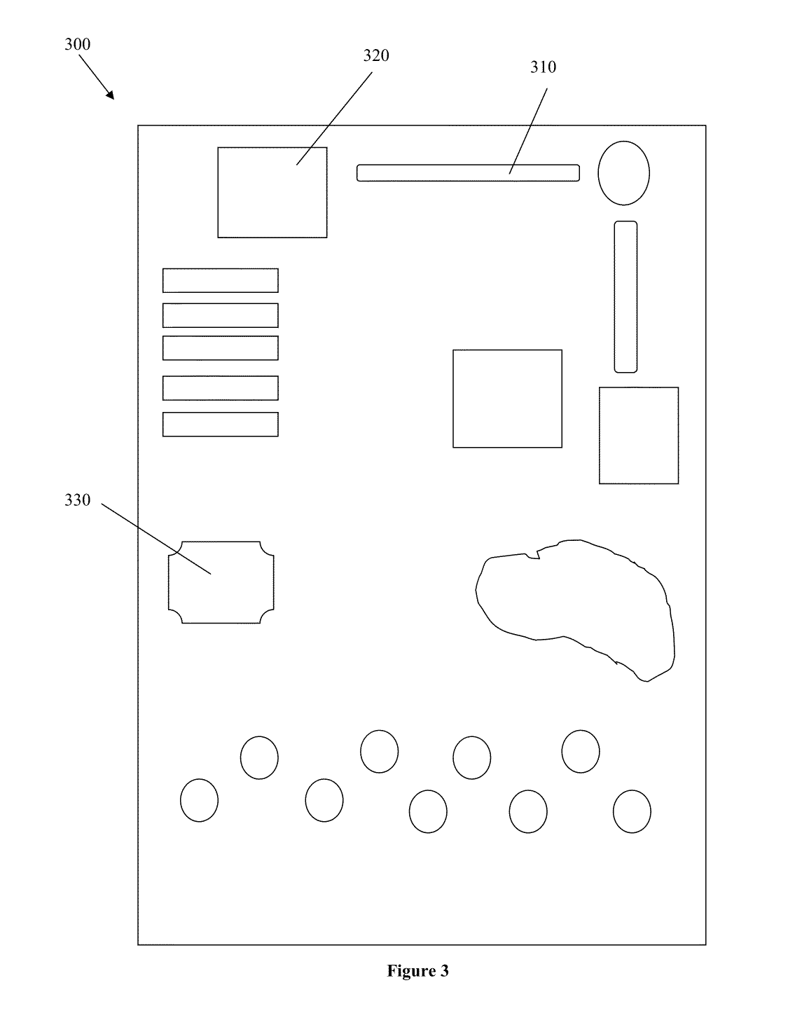

FIG. 2 shows a perspective view of another embodiment of a mobile control device. Mobile control device 200 is a pair of wearable glasses with various electronic components, which will now be described in more detail. The lens portion comprises a transparent display 210. When display 210 is not currently displaying an image, a user wearing device 200 is able to see through display 210 and can observe the surrounding environment. Device 200 has an optical sensor 220 and a thermal sensor 230 for obtaining optical data and thermal data, respectively. Device 100 also has a processor and memory 240, which is communicatively coupled with display 210, sensors 220, 230, and wireless transceiver 250. Transceiver 250 is in communication with at least one external device, and preferably with every controllable system within a facility.

FIG. 3 shows a facility layout 300, with various systems located in the layout (e.g., system 310, system 320, and system 330). Layout 300 also shows non-system features or structures, such as walls, doors, fire extinguishers, emergency exit routes, water faucets, and other building information.

Facility 300 can be a residential house, commercial building, manufacturing plant, nuclear power plant, coal-burning power generation plant, flue gas treatment facility, natural gas processing facility, water-treatment plant, amusement park, cement production plant, mining facility, or any other building or facility that utilizes controllable systems. “Controllable systems” (e.g., systems 310, 320, and 330) are systems, devices, or processes that have adjustable states, parameters, and/or conditions. Adjustments can be made mechanically, electrically, chemically, or by any other means suitable for providing a modification to the system. Examples of controllable systems in a typical residential house include air conditioning and heating units, audio and other media systems, lighting, automatic garage doors, automatic windows/doors, manual windows/doors, refrigerator units, and sprinkler/irritation systems. Examples of controllable systems in a typical manufacturing facility may include conveyor belts, robotic arms, raw material feeders, mixers, temperature controllers, and ovens. Examples of controllable systems in a flue gas treatment facility include boilers, absorbers, fans/blowers, injector systems, coolers, expanders, valves, diffusers, and conduits. The above examples are merely provided for demonstrative purposes and are not intended to be limiting.

Facility layout 300 is fairly simple. Those of skill in the art will appreciate that the inventive concepts described herein provide exponentially greater value as the complexity of a facility layout increases. Contemplated facility layouts include irregular shaped rooms/buildings, multiple rooms or buildings, multi-floored structures, open or uncovered areas. Facility layouts can include multiple structures separated by large physical distances and in different governmental jurisdictions (e.g., different cities, states, countries).

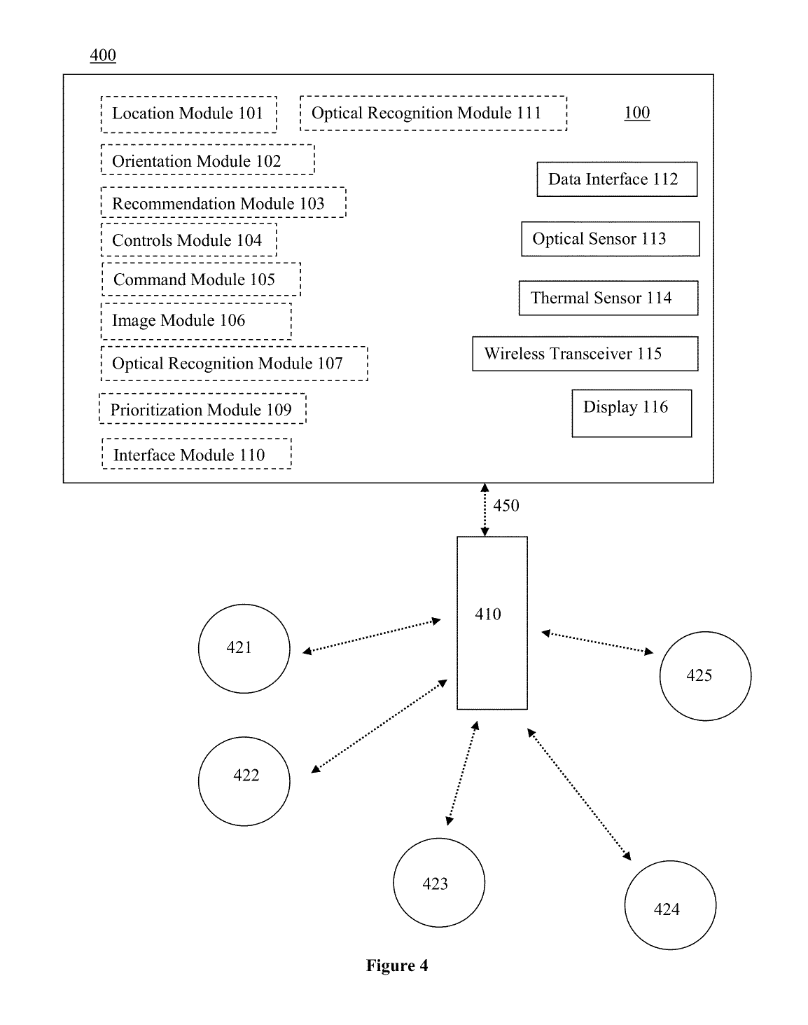

FIG. 4 shows a schematic 400 of device 100 in communication with systems 421-425 via server 410. Systems 421-425 can be any controllable system, as previous described. Server 410 is a conventional server having computing capabilities (e.g., processor, storage medium, executable code). Server 410 can comprise one physical server, multiple servers, virtual processors and storage mediums, and/or distributed processors and storage mediums. Device 100 communicates with server 410 via connection 450. Connection 450 can be wired or wireless. Connection 450 can be a direct connection using wireless protocol (e.g., Bluetooth, WiFi, radio frequencies, cellular protocols) or indirection via another device. Connection 450 could also comprise an internet connection. Connection 450 allows server 410 and device 100 to exchange data.

Device 100 has numerous software components shown conceptually in dotted line boxes and numerous hardware components shown in solid line boxes. The software components or modules are stored on the electronic storage medium of device 100. Each module can comprise a separate file stored on the electronic stored medium. Alternatively, the modules can comprise one integrated file that has different script or code lines for performing the different functional aspects of each module. The names of the modules in FIG. 4 are provided for reference to facilitate explanation of the different functions and features of device 100 and are not intended to be limiting.

Location module 101 determines the location of device 100. Global positioning systems, triangulation analysis, and any other process or device suitable for determining a location is within the scope of contemplated embodiments. Once location module 101 determines a location, it can store location data as location data objects on the storage medium.

Orientation module 102 determines an orientation of device 100. In one embodiment, orientation module 102 utilizes the optical data gathered from optical sensor 112 to determine that device 100 is pointed at, or facing, system 421. Orientation module 102 may also rely on data produced from optical recognition module 107 to identify system 421. System 421 can be identified by its optical characteristics (e.g., shape, size, color, a logo identifier, text/number characters on the system, etc), thermal characteristics (e.g., temperature, temperature spread/distribution/pattern), or by a radio frequency identifier (RFID). Orientation data can be stored as orientation data objects on the electrical storage medium.

Recommendation module 103 generates a controls recommendation, such as a recommendation to shut off a valve, turn down a temperature, turn on a light, slow down a process, unlock a door, or add more constituent to a mixer. Recommendations can be stored as recommendation objects on the storage medium. Recommendation objects can also comprise meta data related to recommendations, for example, whether the recommendation was implemented, when it was implemented, by whom it was implemented, to whom the recommendation was presented, etc. Recommendation module 103 is also configured to provide recommendations as a function of orientation data objects and location data objects. For example, when device 100 is physically near system 425 and pointed at 425, recommendation module 103 provides a control recommendation for system 425.

Controls module 104 analyzes system data from systems 421-425 for the purposes of monitoring, logging, and controlling each system. System data is stored on a storage medium of either server 410 or device 100, or both.

Command module 105 processes commands provided by a user via data interface 112 (e.g., a keyboard, mouse, touch screen, microphone and voice command, etc). Command module 105 sends commands to the systems via wireless transceiver 115, connection 450, and server 410. In other embodiments, command module 104 sends commands directly to each system via a direct connection.

Image module 106 produces images that can be displayed to a user via display 116. Image module 106 is capable of producing composite images, or augmented images, using data gathered from various sensors and sources. For example, image module 106 can produce an image comprising mainly of optical sensor 113 data (e.g., live video camera feed) and augment the optical data with thermal sensor data from thermal sensor 114. Image module 106 is also capable of displaying an association between different data sources and types. Data can be associated by overlaying related data or by marking and labeling data with arrows, titles, descriptions, and the like.

Image module 106 is also capable of determining when data should be displayed and related. In one application, image module 106 determines when to display thermal data based on a maximum allowable temperature for operating a machine or system. When the temperature is within acceptable limits, no thermal data is displayed for that system. When the temperature is outside acceptable limits, thermal data is displayed on display 116 and overlays the optical data that shows the system. The intelligent manner in which image module 106 decides when and how to display different data from different sensors allows a controls manager to safely and efficiently manage hundreds of different systems, machines, and processes within a facility. The predetermined rules that image module 106 uses to produce images can be saved locally on device 100 or remotely on server 410. The rules themselves can change as a function of orientation data and location data.

Optical recognition module 107 is used to identify optical data gathered from optical sensor 113. In one aspect, recognition module 107 is configured to recognize employee faces triggers the display of employee information on display 116. The employee information (e.g., name, job title, technological background, access level) is preferably associated with optical data (e.g., text is displayed next to the employee's face, arrows pointing to the employee's face). In other aspects, recognition module 107 is configured to recognize equipment, machines, locations, facility structure (e.g., ceilings, lights, doors, signs), and the like, and such recognition can trigger information to be displayed on display 116. For example, recognition module 107 could be configured to recognize a machine and then display the machine's shutdown sequence lists, maintenance history, design conditions, exploded parts schematics for equipment, and other related data on display 116. The information (or icons showing the availability of the information) is preferably displayed on 116 in association with real-time optical data of the machine, a 3D model of the machine, or a 3D model of the facility.

Prioritization module 109 prioritizes the processes for analyzing data from data interface 112, transceiver 114, optical sensor 113, and thermal sensor 114. In some embodiments, prioritization module 109 is configured to prioritize when and how information is displayed on display 116. For example, prioritization module 109 could choose when to display thermal data and recommendation data as a function of urgency.

Interface module 110 analyzes and/or stores data received from data interface 112. Data interface 112 comprises hardware and/or software suitable for allowing device 100 to receive data and/or commands from an external device or from a user. Contemplated data interfaces can include a keyboard, mouse, microphone and voice recognition, touch screen, and data ports. In some embodiments, a user sends a command to device 100 via data interface 112 and interface module 110 records and analyzes the command. Interface module 110 can then determine whether an action needs to be taken, such as, displaying information relevant to the command on display 116. For example, a user could inquire about the operational status of system 423 via data interface 112, and interface module 110 can provide the user with information relevant to system 423. The information is preferably displayed on display 116 in association with optical data. In addition, recommendation module 103 could generate a recommendation in response to the user command/inquiry.

Mobile device 100 can be used in conjunction with an actual physical central control room within a facility. Alternatively, mobile device 100 can act as a central control room (e.g., the facility has no physical central control room). It is also contemplated that mobile device 100 could communicate directly with systems 421-425, or indirectly via server 410. The processor and electronic storage medium of mobile device 100 can be located within the device itself or located externally to the device (i.e., shared or distributed processing and data storage). Mobile device 100 could even be configured such that it outsources most of its storage and processing to another device (e.g., virtual processing and virtual memory).

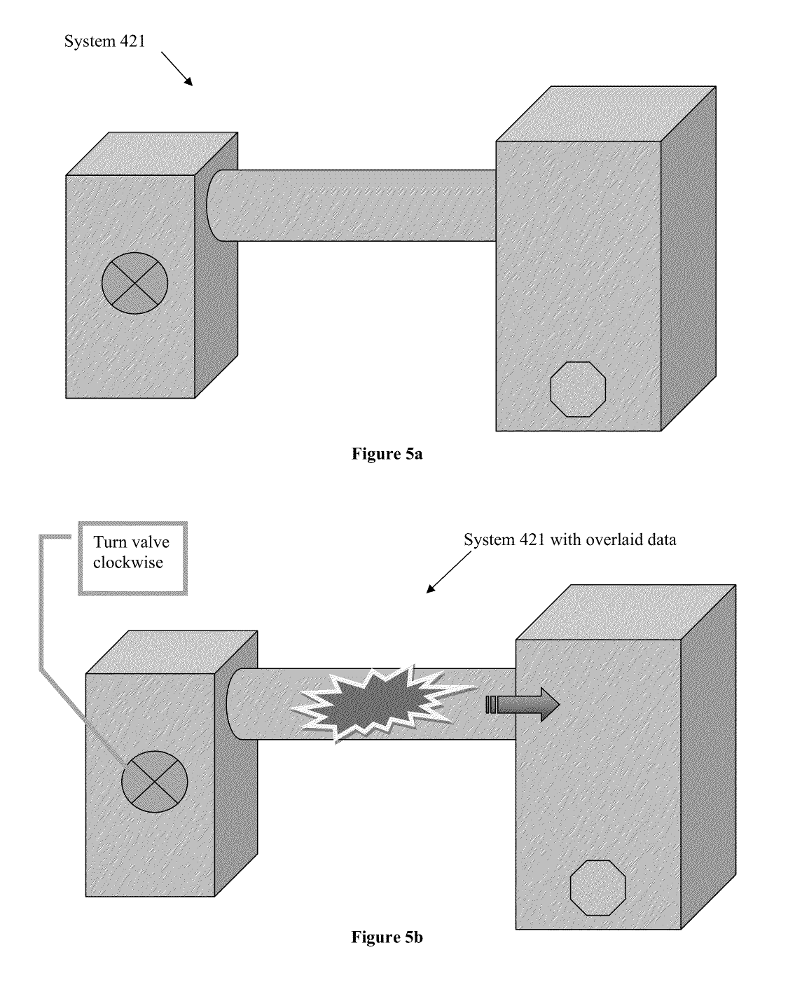

FIGS. 5a and 5b show how information from multiple sources can be associated and displayed together on display 116. FIG. 5a shows optical data for system 421. FIG. 5b shows the optical data for system 421 with thermal data, recommendation data, and descriptive data overlaying the optical data. The thermal data comprises a red cloud gradient along the pipe of system 421, showing the temperature within the pipe. The recommendation data comprises a text box and an arrow, instructing a user to turn the valve in system 421 clockwise. The descriptive data comprises an arrow showing the flow direction of a fluid inside the pipe of system 421. The association of different data in FIG. 5b allows a control manager to quickly assess the operational status of system 421 and determine whether action needs to be taken.

The inventive subject matter provides a new approach to facility controls in which all of the functions normally provided in a control room are available to operators as they move throughout the plant. These functions are provided by use of modern mobile platforms such as heads up displays attached to a helmet (or hard hat), IPad or tablet style devices, or a laptop mounted on a vehicle (e.g., golf cart). Through wireless communication techniques the mobile device sends and receives information/instructions related to controlling the facility under all operating conditions.

Contemplated mobile devices can be easily and frequently updated to include additional functionality via software updates and hardware upgrades. The software updates can include additional features that expand the control manager's ability to control, analyze, and manage the facility and to tailor the functionality to precisely fit their circumstances.

In other aspects, a team of control managers using mobile devices can readily communicate with one another to coordinate the monitoring and controlling of a facility. In such embodiments, each mobile device could display the location of the other devices on a 2D or 3D drawing/model of the facility. Actions of the control managers can be tracked and sent to the other control managers via notifications. The mobile devices preferably take into account the actions of the other control managers when generating recommendations. The networked system of mobile devices allows for constant verification of equipment, key valves, instruments, etc, on a real time basis.

Another advantage of the present inventive subject matter is providing an intelligent system that assists control managers in taking proper actions. For example, in one embodiment the mobile device displays a shutdown sequence list for a machine, checks to see if the machine operator (or the control manager) is physically adjacent to the machine (or a specific component of the device, such as a valve), detects whether the shutdown sequence is being executed properly (e.g., the correct valve was shut off), and provides correctional feedback when the sequence is not properly followed (e.g., the mobile device knows when a wrong valve is shut off). Appropriate alarms and notifications advise the control manager in executing the sequence.

Other sensory data sources can include acoustic data from acoustic sensors within the mobile device. The mobile device an include an acoustic module capable of recognizing fluid flow in pipes, broken/worn bearings, drips, and other acoustic data relevant to controlling and monitoring facilities. The acoustic data is preferably used to generate recommendations and is displayed on the mobile device in association with other categories of data.

Contemplated mobile devices can also be used to enter maintenance orders, communicate with management, and obtain input from specialists from the field (e.g., while the control manager moves throughout the facility). This capability advantageously allows control managers and machine operators to coordinate complex tasks in the desired sequence.

In another aspect of the inventive subject matter, the mobile device can be used to update a 3D model of the facility by comparing optical data of the facility with the 3D model. It is commonplace for the 3D models used during construction or modification of facilities to become out of date. Depending on the size of the facility, it can be quite costly to update the 3D models with changes that can occur throughout construction or modification. It would be advantageous to use the mobile device described above to passively observe the facility as the controls manager roams the facility, and look for outdated sections in the 3D model. When differences and inconsistencies are detected between the actual facility (e.g., optical data of the actual facility) and the 3D model, the mobile device is configured to query the Controls Manager (e.g., via an audio or visual signal), or both as to whether to update the 3D model or initiate a maintenance work order to correct the facility.

In some embodiments, the alert could comprise a visual object/artifact (e.g., blinking, highlighting, text box and arrow, icon) displayed on the mobile device's display. The visual object is preferably associated with optical data of the facility, such as by being placed next to or overlaying the optical data.

Examples of inconsistencies include, but are not limited to, structural changes to the facility (windows, doors, walls, cable runs, pipes, etc) and the location of systems and machines within or near the facility. As such, contemplated mobile devices can be used to detect when furniture or equipment has been re-arranged in a room. The mobile device can alert the controls manager (or mobile device user) of the inconsistencies and present the controls manager with the option of ignoring the inconsistency or updating the 3D model. It is also contemplated that the mobile device could include software capable of directly communicating with the 3D model (CAD supported) or alternatively, could provide updates via another device (server).

In other aspects, the mobile devices contemplated herein could be used to track the location and actions of personnel within the facility (e.g., workers, maintenance personnel, visitors, controls managers, etc.). Personnel can be tracked via the mobile device's optical sensor and using face/object recognition, by carrying a device that emits radio frequency signals suitable for determining location (e.g., global positioning systems and devices), or by any other technology suitable for tracking location. Tracking personnel within the facility provides several advantages. First, it allows personnel with access rights/privileges to the mobile device to initiate controls actions when in close proximity to the controlled item. Second, the personnel with access rights/privileges to the mobile device can use the device to direct others to exit the building via the safest escape route during an emergency (fire, earthquake, nuclear leak, gas leak, etc).

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints and open-ended ranges should be interpreted to include commercially practical values. Similarly, all lists of values should be considered as inclusive of intermediate values unless the context indicates the contrary.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A mobile control device for monitoring and controlling a plurality of systems within a facility, comprising:
a processor;
an electronic storage medium communicatively coupled with the processor and having a plurality of executable instructions stored therein;
a display communicatively coupled with the processor;
a wireless communication device coupled with the processor and configured to communicate with at least one of the plurality of systems; and
wherein the plurality of executable instructions includes
(i) a location module that determines and tracks a location of the mobile control device;
(ii) an orientation module that determines an orientation of the mobile control device;
(iii) a recommendation module that generates a recommendation as a function of the location and orientation of the device and displays the recommendation on the display;
(iv) a controls module that processes system data objects received from at least one of the plurality of systems, wherein the system data objects represent operational parameters;
(v) a command module for transmitting and logging commands to the plurality of systems.

2. The mobile control device of claim 1, further comprising a plurality of sensors configured to obtain sensor derived data.

3. The mobile control device of claim 1, wherein the plurality of sensors includes an optical sensor, a thermal sensor, and an acoustic sensor configured to obtain optical data, thermal data, and acoustic data, respectively.

4. The mobile control device of claim 3, wherein the plurality of executable instructions further includes an image module configured to produce an image and display the image on the display.

5. The mobile control device of claim 4, wherein the image includes at least a subset of the sensor derived data.

6. The mobile control device of claim 5, wherein the composite image primarily comprises optical data.

7. The mobile control device of claim 6, wherein the composite image shows an association between the optical data and other sensor derived data.

8. The mobile control device of claim 7, wherein the composite image shows optical data overlaid with other sensor derived data.

9. The mobile control device of claim 4, wherein the image module selects sensor derived data to include in the composite image as a function of at least one system rule.

10. The mobile control device of claim 9, wherein the system rule comprises a maximum or minimum for a system.

11. The mobile control device of claim 10, wherein the image module associates at least one of the sensor derived data with at least one of the optical data as a function of location and orientation.

12. The mobile control device of claim 11, wherein the plurality of executable instructions further includes an optical recognition module configured to recognize optical data.

13. The mobile control device of claim 12, wherein the optical data includes an identifier object that is recognizable by the recognition module.

14. The mobile control device of claim 13, wherein identifier object comprises an RFID object.

15. The mobile control device of claim 14, wherein the image module associates at least one of the sensor derived data with at least one of the optical data as a function of the identifier object.

16. The mobile control device of claim 1, wherein the image module produces an image that includes at least one of the optical data and the recommendation.

17. The mobile control device of claim 16, wherein the image shows an association between the recommendation and at least one optical data.

18. The mobile control device of claim 1, wherein the location module comprises at least one of a GPS receiver and an RFID receiver.

19. The mobile control device of claim 1, further comprising a mount sized and disposed on the device to mount the device to a vehicle.

20. The mobile control device of claim 1, further comprising a mount sized and disposed on the device to mount the device to a helmet.

21. The mobile control device of claim 1, wherein the device is incorporated integrally in a fighter pilot style heads up helmet.

22. The mobile control device of claim 1, wherein the electronic storage medium further includes a plurality of facility layout data objects that represent a layout of the facility.

23. The mobile control device of claim 21, wherein the location module displays a layout of the facility on the display, and the location and the orientation of the device with respect to the facility layout.

24. The mobile control device of claim 1, wherein the display further comprises a user interface for receiving user commands.

25. The mobile control device of claim 1, wherein the recommendation module is configured to indicate when a recommendation has been implemented on the display.
